(19) United States
(12) Patent Application Publication
(10) Pub. No.: US 2004/0201815 A1
(43) Pub. Date: Oct. 14, 2004

(54) Liquid crystal display apparatus and method of manufacturing the same

(76) Inventor: Takeshi Yamamoto, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/749,397

(22) Filed: Jan. 2, 2004

(30) Foreign Application Priority Data
Jan. 10, 2003 (JP) 2003-004179

(51) Int. Cl. G02F 1/1339

(52) U.S. Cl. 349/156

(57) ABSTRACT

A liquid crystal display apparatus includes a first gap region with a first gap for interposition of a liquid crystal layer between a first substrate and a second substrate, a second gap region with a second gap that is smaller than the first gap, a first columnar spacer that is formed in the first gap region on the first substrate, and a second columnar spacer that is formed in the second gap region on the first substrate. The contact area of the first columnar spacer, which contacts the first substrate, is greater than the contact area of the second columnar spacer, which contacts the first substrate.

### CROSS-REFERENCE TO RELATED APPLICATIONS

This application is based upon and claims the benefit of priority from the prior Japanese Patent Application No. 2003-004179, filed Jan. 10, 2003, the entire contents of which are incorporated herein by reference.

### BACKGROUND OF THE INVENTION

1. Field of the Invention

The present invention relates to a liquid crystal display apparatus and a method of manufacturing the same. More particularly, the invention relates to a liquid crystal display apparatus having a multi-gap structure wherein a gap, with which a liquid crystal layer is interposed, varies from pixel to pixel, and to a method of manufacturing this liquid crystal display apparatus.

2. Description of the Related Art

In present-day commonly used liquid crystal display apparatuses, a liquid crystal layer is interposed between two glass substrates having electrodes. A gap, with which the liquid crystal layer is interposed, is kept by a spacer such as a plastic bead.

In a liquid crystal display apparatus for color display, color filter layers, which are colored in red, green (G) and blue (B), respectively, are provided on one of the substrates in association with respective pixels. Specifically, a red pixel has a red color filter layer. A green pixel has a green color filter layer. A blue pixel has a blue color filter layer.

The viewing angle characteristics of the liquid crystal display apparatus depend greatly on the gap between the substrates that sandwich the liquid crystal layer. Where an inter-substrate gap is d, a refractive index anisotropy of a liquid crystal composition of the liquid crystal layer is Δn, the wavelength of light passing through the liquid crystal layer is λ, and u=2·d·Δn/λ, a light transmittance T is generally given by

T=sin²[((1+u²)^{1/2}·π/2)/(1+u²)].

In other words, the effective thickness (d·Δn) of the liquid crystal layer, which maximizes the transmittance T of light passing through the liquid crystal layer, varies depending on the wavelength of the transmission light.

Under the circumstances, there has been proposed a liquid crystal display apparatus having a multi-gap structure, wherein the gap between the substrates that sandwich the liquid crystal layer varies from color pixel to color pixel. In the multi-gap structure, the thicknesses of color filter layers are different between the associated colors. Jpn. Pat. Appln. KOKAI Publication No. 6-347802, for instance, discloses a technique wherein a plurality of kinds of spherical or columnar plastic spacers are dispersed on one of the substrates.

In the liquid crystal display apparatus with the conventional multi-gap structure, however, it is necessary to prepare a plurality of kinds of spacers having different diameters in accordance with the varied gap, or to prepare a plurality of kinds of spacers with different densities. Furthermore, in the manufacturing process, it is difficult to provide a plurality of kinds of spacers corresponding to the varied gap at the same time in the same step, which leads to an increase in number of fabrication steps. The provision of a plurality of kinds of spacers and the increase in number of fabrication steps will raise the manufacturing cost and lower the manufacturing yield.

Even if the number of fabrication steps is reduced by dispersing spacers in the liquid crystal composition and thus simultaneously providing the spacers and injecting liquid crystal, it is not possible to strictly control the density of spacers that are to be dispersedly applied for each pixel. Consequently, spacers may locally coagulate (e.g. stacking of spherical spacers in the thickness direction of the liquid crystal layer), and a desired gap could not be obtained, resulting in defective display. Moreover, a defect in alignment of the liquid crystal may occur in the vicinity of spherical or columnar spacers, leading to a defect in display.

### BRIEF SUMMARY OF THE INVENTION

The present invention has been made in consideration of the above-described problems, and its object is to provide a liquid crystal display apparatus, which can achieve a high manufacturing yield at low cost, and can realize a high display quality, and a method of manufacturing the same.

According to a first aspect of the present invention, there is provided a liquid crystal display apparatus configured to have a liquid crystal layer interposed between a first substrate and a second substrate, comprising: a first gap region with a first gap for interposition of the liquid crystal layer between the first substrate and the second substrate; a second gap region with a second gap that is smaller than the first gap; a first columnar spacer that is formed in the first gap region on the first substrate; and a second columnar spacer that is formed in the second gap region on the first substrate, wherein a contact area of the first columnar spacer, which contacts the first substrate, is greater than a contact area of the second columnar spacer, which contacts the first substrate.

According to a second aspect of the present invention, there is provided a method of manufacturing a liquid crystal display apparatus configured to have a liquid crystal layer interposed between a first substrate and a second substrate, comprising: forming a spacer material on the first substrate; patterning the spacer material with a first size in accordance with a first gap region that includes a first gap for interposition of the liquid crystal layer, and patterning the spacer material with a second size, which is smaller than the first size, in accordance with a second gap region that includes a second gap, which is smaller than the first gap; and melting the spacer material that is patterned in each of the first gap region and the second gap region, and adjusting a height of the spacer material patterned in the first gap region and a height of the spacer material patterned in the second gap region.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

FIG. 1 schematically shows the structure of a liquid crystal display panel that is applied to a liquid crystal display apparatus of the present invention;

FIG. 2 is a circuit block diagram schematically showing the composition of the liquid crystal display panel shown in FIG. 1;

FIG. 3 is a cross-sectional view schematically showing the structure of a liquid crystal display apparatus according to an embodiment of the present invention;

FIG. 4 is a cross-sectional view schematically showing the structure of an array substrate that forms the liquid crystal display apparatus shown in FIG. 3;

FIG. 5 is a graph illustrating a relationship between the magnitude of a columnar spacer, which is applicable to the liquid crystal display panel shown in FIG. 2, and the height of the columnar spacer;

FIG. 6 is a cross-sectional view schematically showing the structure of a liquid crystal display apparatus according to another embodiment of the present invention; and

FIG. 7 is a cross-sectional view schematically showing the structure of a liquid crystal display apparatus according to another embodiment of the present invention.

The accompanying drawings, which are incorporated in and constitute a part of the specification, illustrate embodiments of the invention, and together with the general description given above and the detailed description of the embodiments given below, serve to explain the principles of the invention.

### DETAILED DESCRIPTION OF THE INVENTION

A liquid crystal display apparatus and a method of manufacturing the same, according to an embodiment of the present invention, will now be described with reference to the accompanying drawings.

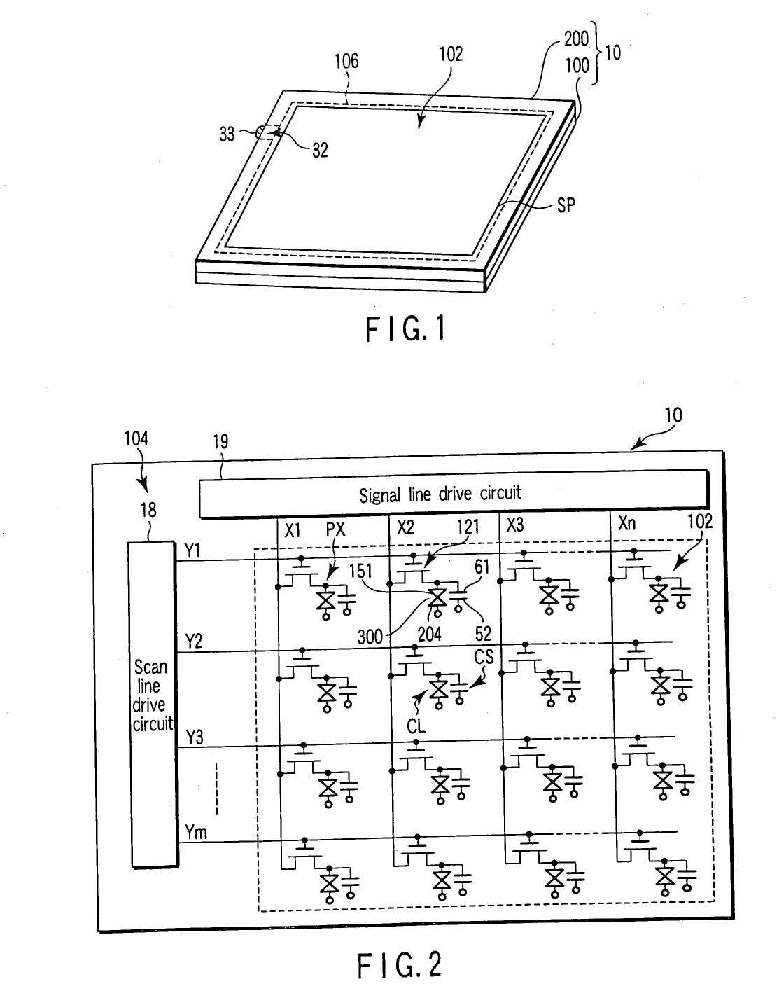

As is shown in FIG. 1 and FIG. 2, a liquid crystal display apparatus according to the embodiment, for example, an active-matrix liquid crystal display apparatus, includes a liquid crystal display panel 10. The liquid crystal display panel 10 comprises an array substrate 100, a counter substrate 200 that is disposed to face the array substrate 100, and a liquid crystal layer 300 that is interposed between the array substrate 100 and counter substrate 200. The array substrate 100 and counter substrate 200 are attached to each other by a seal material 106, with a predetermined gap for interposition of the liquid crystal layer 300 being created therebetween. The liquid crystal layer 300 is formed of a liquid crystal composition that is sealed in the gap defined between the array substrate 100 and counter substrate 200.

In the liquid crystal display panel 10, a display region 102 for displaying an image comprises a plurality of pixels PX that are arranged in a matrix. A peripheral edge portion of the display region 102 is light-shielded by a shield layer SP that is formed in a picture-frame shape.

In the display region 102, the array substrate 100, as shown in FIG. 2, includes an m×n number of pixel electrodes 151, an m-number of scan lines Y1 to Ym, an n-number of signal-lines X1 to Xn, and an m×n number of switching elements 121. On the other hand, in the display region 102, the counter substrate 200 includes a counter electrode 204.

The pixel electrodes 151 are disposed in a matrix in the display region 102. The scan lines Y are disposed in the row direction of the pixel electrodes 151. The signal lines X are disposed in the column direction of the pixel electrodes 151. The switching elements 121 are formed of thin-film transistors with polysilicon semiconductor layers, i.e. pixel TFTs. The switching elements 121 are provided in association with the respective pixels PX and are disposed near intersections of the scan lines Y and signal lines X. The counter electrode 204 is commonly provided for all the pixels PX. The counter electrode 204 is opposed to all the m×n pixel electrodes 151 via the liquid crystal layer 300.

The array substrate 100 includes, in a peripheral region 104 around the display region 102, a scan line drive circuit 18 including drive TFTs for driving the scan lines Y1 to Ym, and a signal line drive circuit 19 including drive TFTs for driving the signal lines X1 to Xn. The drive TFTs included in the scan line drive circuit 18 and signal line drive circuit 19 are composed of n-channel thin-film transistors and p-channel thin-film transistors with polysilicon semiconductor layers.

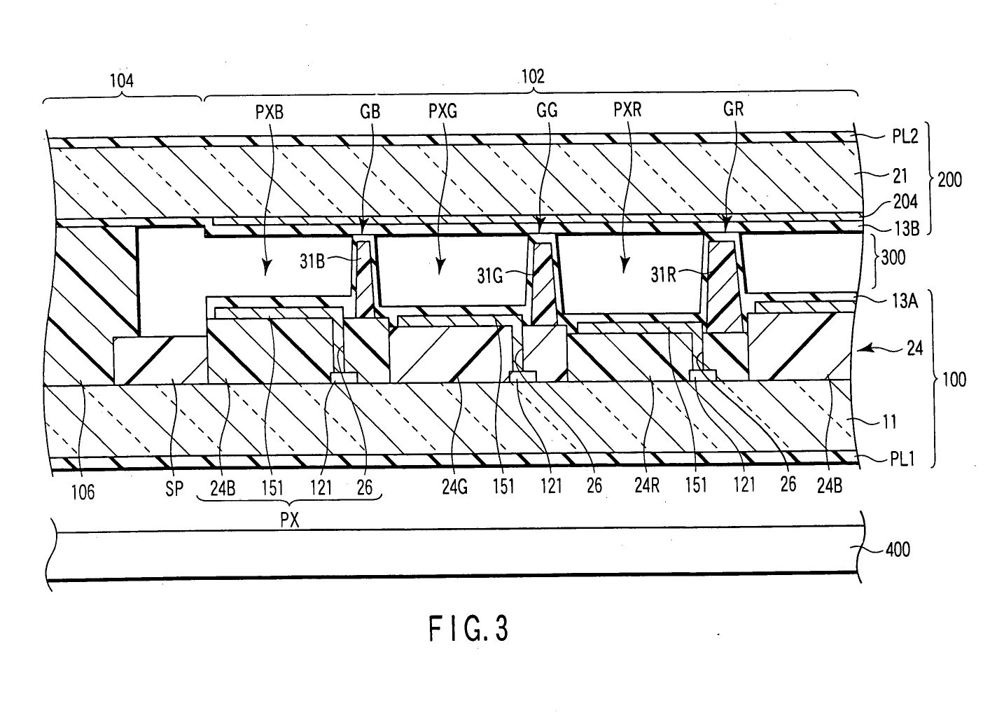

The liquid crystal display panel 10 shown in FIGS. 1 and 2 is of a transmission type wherein light is selectively passed, for example, from the array substrate 100 side to the counter substrate 200 side. Thus, the liquid crystal display apparatus includes, as shown in FIG. 3, a transmission-type liquid crystal display panel 10 and a backlight unit 400 that illuminates the liquid crystal display panel 10 from the back side (i.e. outer-surface side of array substrate 100).

In the display region 102 of the liquid crystal display apparatus shown in FIG. 3, the array substrate 100 includes, on a transparent insulative substrate 11 such as a glass substrate, pixel TFTs 121 arranged for the respective pixels PX, color filters 24 (R, G, B) formed to cover the pixel TFTs 121, pixel electrodes 151 disposed on the color filter layers 24 (R, G, B) for the respective pixels PX, columnar spacers 31 (R, G, B) disposed on the color filter layer 24 (R, G, B), respectively, and an alignment film 13A formed to cover the entire pixel electrodes 151. In the peripheral region 104, the array substrate 100 includes the shield layer SP so as to surround the outer periphery of the display region 102.

A red pixel PXR includes a red color filter layer 24R. A green pixel PXG includes a green color filter layer 24G. A blue pixel PXB includes a blue color filter layer 24B. The color filter layers 24 (R, G, B) are composed of color resin layers that are colored in red (R), green (G) and blue (B). The color filter layers 24 (R, G, B) mainly pass red light, green light and blue light, respectively.

The pixel electrode 151 is formed of a light-transmissive electrically conductive material such as ITO (Indium Tin Oxide). Each pixel electrode 151 is connected to the associated pixel TFT 121 via a through-hole 26 that penetrates the associated color filter layer 24 (R, G, B).

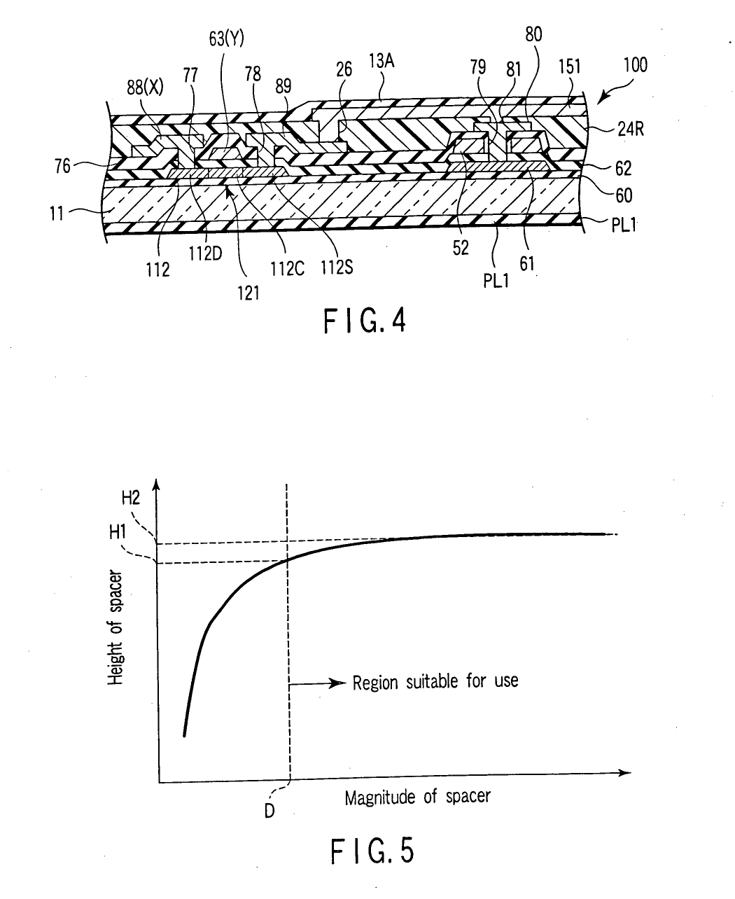

FIG. 4 shows the structure of each pixel TFT 121 in greater detail. The pixel TFT 121 includes a semiconductor layer 112 that is formed of polysilicon. The semiconductor layer 112 is disposed on an undercoating layer 60 formed on the insulative substrate 11. The semiconductor layer 112 includes a drain region 112D and a source region 112S, which are formed by doping areas on both sides of a channel region 112C with impurities.

A gate electrode 63 of the pixel TFT 121 is formed integral with the scan line Y. The gate electrode 63 is disposed to be opposed to the semiconductor layer 112 via a gate insulation film 62. A drain electrode 88 is formed integral with the signal line X. The drain electrode 88 is electrically connected to the drain region 112D of the semiconductor layer 112 via a contact hole 77 that penetrates the gate insulation film 62 and an interlayer insulation film 76. The source electrode 89 is electrically connected to the source region 112S of the semiconductor layer 112 via a contact hole 78 that penetrates the gate insulation film 62 and interlayer insulation film 76. In addition, the source electrode 89 is electrically connected to the pixel electrode 151 via a through-hole 26 formed in the color filter layer 24 (R, G, B). Thereby, the pixel TFT 121 is connected to the scan line Y and signal line X. The pixel TFT 121 is turned on by a drive voltage that is applied from the scan line Y and applies a signal voltage from the signal line X to the pixel electrode 151.

The pixel electrode 151 is electrically connected to an auxiliary capacitance element 61 that forms an auxiliary capacitance CS, which is electrically in parallel with a liquid crystal capacitance CL. The auxiliary capacitance electrode 61 is formed of a polysilicon film that is doped with impurities. The auxiliary capacitance electrode 61, like the semiconductor layer 112, is disposed on the undercoating layer 60. A contact electrode 80 is electrically connected to the auxiliary capacitance electrode 61 via a contact hole 79 that penetrates the gate insulation film 62 and interlayer insulation film 76. The pixel electrode 151 is electrically connected to the contact electrode 80 via a contact hole 81 that penetrates the color filter layer 24. Thereby, the potentials of the source electrode 89 of pixel TFT 121, the pixel electrode 30 and the auxiliary capacitance electrode 61 are equalized. On the other hand, an auxiliary capacitance line 52 has at least a part that is disposed to be opposed to the auxiliary capacitance electrode 61 via the gate insulation film 62, and the auxiliary capacitance line 52 is set at a predetermined potential.

The wiring including the signal lines X, scan lines Y and auxiliary capacitance lines 52 is formed of light-shielding low-resistance material such as aluminum or molybdenum-tungsten. In this embodiment, the scan lines Y and auxiliary capacitance lines 52, which are disposed substantially in parallel, are formed of molybdenum-tungsten. The signal lines X, which are disposed substantially perpendicular to the scan lines Y via the interlayer insulation film 76, are mainly formed of aluminum. The drain electrode 88 which are integral with the signal line X, source electrode 89 and contact electrode 80, are mainly formed of aluminum, like the signal line.

On the other hand, as shown in FIG. 3, the shield layer SP is formed of a photosensitive resin material with light-shield properties for preventing passage of light, for example, a color resin such as a black resin. The columnar spacers 31 (R, G, B) are formed of a color resin such as a black resin. The shield layer SP and columnar spacers 31 (R, G, B) can be formed of the same material in the same step. Thereby, the number of fabrication steps can be decreased, and the manufacturing cost reduced. The columnar spacers 31 (R, G, B) are disposed on the respective color filter layers 24 (R, G, B) so as to be located on the wiring with light-shield properties. The alignment film 13A functions to align liquid crystal molecules included in the liquid crystal layer 300 in a predetermined direction.

The counter substrate 200 includes the counter electrode 204 that is formed on a transparent insulative substrate 21 such as a glass substrate, and an alignment film 13B that covers the counter electrode 204. The counter electrode 204 is formed of a light-transmissive electrically conductive material such as ITO. The alignment film 13B functions to align liquid crystal molecules included in the liquid crystal layer 300 in a predetermined direction. A polarizing plate PL1 is provided on an outer surface of the array substrate 100. A polarizing plate PL2 is provided on an outer surface of the counter substrate 200.

In the above-described liquid crystal display apparatus, light emitted from the backlight unit 400 illuminates the liquid crystal display panel 10 from the outer surface side of the array substrate 100. The light that has passed through the polarizing plate PL1 and entered the liquid crystal display panel 10 is modulated while it is passing through the liquid crystal layer 300. The modulated light selectively passes through the polarizing plate PL2 of the counter substrate 200. Thus, an image is displayed on the display region 102 of liquid crystal display panel 10.

The above-described liquid crystal display panel 10 has a multi-gap structure wherein the gap between the substrates that sandwich the liquid crystal layer 300 varies from color pixel to color pixel. In other words, the gap between the substrates at each pixel PX (i.e. the gap corresponding to a thickness d of the liquid crystal layer 300 that is sandwiched between the alignment film 13A of array substrate 100 and the alignment film 13B of counter substrate 200) is determined by the dominant wavelength of light that passes through the color filter layer 24 (R, G, B) disposed at the pixel PX. Specifically, the effective thickness (d·Δn) of the liquid crystal layer 300, which is determined in consideration of a refractive index anisotropy Δn of the liquid crystal layer 300, is set so as to maximize the transmittance T of the light that passes through the liquid crystal layer 300 (i.e. the dominant wavelength of light that passes through the color filter layer 24 (R, G, B) disposed at each pixel PX).

In the embodiment shown in FIG. 3, in the case where the array substrate 100 and counter substrate 200 are arranged in parallel, the film thickness of the red color filter layer 24R is the minimum and the film thickness of the blue color filter layer 24B is the maximum. The following relationship is established:

the film thickness of the red color filter layer<the film thickness of the green color filter layer<the film thickness of the blue color filter layer.

Thereby, two kinds or more of pixels with different gaps are formed in the display region 102. That is, the multi-gap structure is formed, wherein the gap is the maximum at the red pixel PXR having the red color filter layer 24R and the gap is the minimum at the blue pixel PXB having the blue color filter layer 24B. The following relationship is established:

the gap of the red pixel>the gap of the green pixel>the gap of the blue pixel.

The presupposed condition of the above-described multi-gap structure is that the array substrate 100 and counter substrate 200 are parallel to each other. It is necessary, therefore, to dispose columnar spacers that have different heights corresponding to different gaps at the respective pixels. In this embodiment, the sizes of the columnar spacers are properly set in accordance with the film thicknesses (i.e. gaps at the respective pixels) of the color filter layers 24 (R, G, B), thereby forming the multi-gap structure.

In the above-described multi-gap structure, if columnar spacers of the same shape are disposed, the columnar spacers disposed on the respective color filter layers 24 (R, G, B) have the same height. In this case, the columnar spacers can support the minimum gap but cannot support gaps with greater sizes.

FIG. 5 shows a relationship that has been found between the magnitude and the height of the columnar spacer. This relationship between the magnitude and height relates to columnar spacers that were formed by coating the same photosensitive resin material under the same conditions, and then exposing and developing the coated material. The magnitude of the columnar spacer can be varied by altering the size of the mask pattern in the exposure step. The “magnitude” of the columnar spacer, in this context, is defined by a cross-sectional area (i.e. contact area), in a plane parallel to the substrate, of a bottom surface of the columnar spacer, that is, a contact surface of the columnar spacer which contacts an underlayer (e.g. color filter layer). The shape of the contact surface is regular-polygonal, circular, oval, etc. The “height” of the columnar spacer refers to a distance between the bottom surface of the columnar spacer and a vertically highest point of the columnar spacer (e.g. a point closest to the counter substrate).

Alternatively, the magnitude of the columnar spacer may refer to the volume thereof, or the dimensions thereof. The “volume”, in this context, is defined as the total amount of photosensitive resin material that is used to form a single columnar spacer. The “dimensions” is defined as a cross-sectional area of the columnar spacer in a horizontal plane (i.e. plane parallel to the substrate) at a middle point of the height of the columnar spacer.

As is understood from FIG. 5, the height of the columnar spacer increases in accordance with an increase in magnitude of the columnar spacer. In the process of forming the columnar spacer, spacer material (i.e. photosensitive resin material) is melted, and finally cured and contracted. The height of the columnar spacer is determined by the influence of the magnitude of the columnar spacer when the material is melted and cured/contracted.

In order to decrease a variance in fabrication process, it is desirable to use the spacer with such a magnitude that the height of the columnar spacer is stabilized to a certain degree. Specifically, as shown in FIG. 5, when the magnitude of the columnar spacer is less than D, the height obtained varies sharply. Consequently, a slight difference in condition (variance in fabrication process) may lead to failure in attaining a desired height. By adjusting the magnitude of the columnar spacer at D or more, the height to be attained can be controlled in a relatively narrow range between H1 and H2. It has been found that when an ordinary photosensitive resin material is used, the height obtained is stabilized by setting the magnitude of the columnar spacer with a substantially square contact surface at about (5 μm×5 μm) or more.

Hence, in the case of the multi-gap structure, as shown in FIG. 3, which has the following relationship,

gap of red pixel>gap of green pixel>gap of blue pixel,

the magnitudes of the columnar spacer 31R at the red pixel PXR, the columnar spacer 31G at the green pixel PXG and the columnar spacer 31B at the blue pixel PXB are set to meet the relationship,

columnar spacer 31R>columnar spacer 31G>columnar spacer 31B. Thereby, the heights of the respective columnar spacers 31 (R, G, B) can be set to meet the relationship,

columnar spacer 31R>columnar spacer 31G>columnar spacer 31B. Thus, a desired gap can be created at each pixel so that the transmittance T of light that passes through the liquid crystal layer 300 can take a maximum value.

The above-mentioned multi-gap structure is described in greater detail. For example, in the structure shown in FIG. 3, attention is paid to the red pixel PXR and blue pixel PXB.

The display region 102 includes at least two kinds of pixels PXR and PXB with different gaps, which are arranged in a matrix. Each pixel includes a gap region with a gap for interposition of the liquid crystal layer 300. The red pixel (first pixel) PXR has a first gap region GR with a first gap. The blue pixel (second pixel) PXB has a second gap region GB with a second gap that is smaller than the first gap. The “pixel”, in this context, refers to a region surrounded by various lines such as scan lines, signal lines and auxiliary capacitance lines, and this region includes areas over these lines. The “gap region” is formed within the pixel including the various lines.

The array substrate (first substrate) 100 includes a first columnar spacer 31R that is formed in the first gap region GR, and a second columnar spacer 31B that is formed in the second gap region GB. The first columnar spacer 31R is formed to have a greater magnitude than the second columnar spacer 31B. Specifically, the contact area of the first columnar spacer 31R, which contacts the array substrate 100, is greater than the contact area of the second columnar spacer 31B, which contacts the array substrate 100. In addition, the dimensions of the first columnar spacer 31R is greater than that of the second columnar spacer 31B. Moreover, the volume of the first columnar spacer 31R is greater than that of the second columnar spacer 31B.

In this case, each of the first columnar spacer 31R and second columnar spacer 31B is formed to have a magnitude of D or more, as has been described with reference to FIG. 5. Thus, the height of each of the formed first columnar spacer 31R and second columnar spacer 31B can be controlled within the range between H1 and H2. Needless to say, the first gap and second gap are set within the range between H1 and H2.

Accordingly, the first columnar spacer 31R with a proper magnitude is formed to have a height that corresponds to the first gap. The second columnar spacer 31B with a proper magnitude is formed to have a height that corresponds to the second gap. Therefore, a desired multi-gap structure can exactly be formed by the first columnar spacer 31R and second columnar spacer 31B.

The first gap and second gap can be controlled by the film thicknesses of the color filter layers that are disposed at the associated pixels. Specifically, the first gap region GR includes the red color filter layer (first color filter layer) 24R that mainly passes red color (first color) light. The second gap region GB includes the blue color filter layer (second color filter layer) 24B that mainly passes blue color (second color) light.

The array substrate 100 includes the red color filter layer 24R in association with the red pixel PXR, and includes the first columnar spacer 31R in association with the first gap region GR. In addition, the array substrate 100 includes the blue color filter layer 24B in association with the blue pixel PXB, and includes the second columnar spacer 31B in association with the second gap region GB.

The red color filter layer 24R has a first film thickness of, e.g. 3.0 μm. On the other hand, the blue color filter layer 24B has a second film thickness of, e.g. 4.0 μm, which is greater than the first film thickness.

The first columnar spacer 31R is disposed on the red color filter layer 24R, and contacts the counter substrate (second substrate) 200 and creates a first gap of, e.g. 5.0 μm, for interposition of the liquid crystal layer 300 between the array substrate 100 and counter substrate 200. In other words, the first columnar spacer 31R has a first height of about 5.0 μm. The second columnar spacer 31B is disposed on the blue color filter layer 24B, and contacts the counter substrate 200 and creates a second gap of e.g. 4.0 μm, which is smaller than the first gap, for interposition of the liquid crystal layer 300 between the array substrate 100 and counter substrate 200. In other words, the second columnar spacer 31B has a second height of e.g. 4.0 μm, which is smaller than the first height.

The sum of the first film thickness of the red color filter layer 24R and the first height of the first columnar spacer 31R (e.g. 3.0 μm+5.0 μm=8.0 μm) is substantially equal to the sum of the second film thickness of the blue color filter layer 24B and the second height of the second columnar spacer 31B (e.g. 4.0 μm+4.0 μm=8.0 μm). Thereby, a desired multi-gap structure can be formed.

The heights of the first columnar spacer 31R and second columnar spacer 31B can be controlled by adjusting the magnitudes thereof. Specifically, the cross-sectional area of the bottom surface of the first columnar spacer 31R (i.e. contact area with the array substrate) is set to be greater than the cross-sectional area of the bottom surface of the second columnar spacer 31B. Thereby, the height of the first columnar spacer 31R is set to be greater than that of the second columnar spacer 31B. Since the columnar spacers 31R and 31B can be formed of the same material in the same step, there is no need to provide a step of individually forming columnar spacers with different heights.

Next, a method of fabricating the liquid crystal display panel 10 is described.

In the step of fabricating the array substrate 100, an undercoating layer 60 is formed on the insulative substrate 11. Then, a polysilicon semiconductor layer 112 of, e.g. a pixel TFT 121, and an auxiliary capacitance electrode 61 are formed. After a gate insulation film 62 is formed, various lines such as a scan line Y, an auxiliary capacitance line 52 and a gate electrode 63 that is integral with the scan line Y are formed.

Subsequently, using the gate electrode 63 as a mask, impurities are implanted in the polysilicon semiconductor layer 112, thereby forming a drain region 112D and a source region 112S. The resultant structure is annealed to activate the impurities. Then, after an interlayer insulation film 76 is formed, a signal line X is formed. In addition, a drain electrode 88 of the pixel TFT 121, which is integral with the signal line X, a source electrode 89, and a contact electrode 80 are formed. The drain electrode 88 contacts the drain region 112D via a contact hole 77. The source electrode 89 contacts the source region 112S via a contact hole 78. The contact electrode 80 contacts the auxiliary capacitance electrode 61 via a contact hole 79.

Following the above, color filter layers 24 (R, G, B) of colors corresponding to the respective color pixels are formed. Specifically, using a spinner, an ultraviolet-curing acrylic resin resist film CR-2000 (manufactured by Fujifilm Olin Co., Ltd.), in which a red pigment is dispersed, is coated on the entire surface of the substrate. Then, using a photomask with a pattern corresponding to the red pixel, the resist film is exposed with a wavelength of 365 nm at an exposure amount of 100 mJ/cm². The resist film is developed for 20 seconds in a 1% aqueous solution of KOH. The developed resist film is rinsed and baked. Thus, a red color filter layer 24R that is 3.0 μm thick is formed.

Similar steps are repeated. A green color filter layer 24G that is 3.4 μm thick and is formed of an ultraviolet-curing acrylic resin resist film CG-2000 (manufactured by Fujifilm Olin Co., Ltd.), in which a green pigment is dispersed, is formed. A blue color filter layer 24B that is 4.0 μm thick and is formed of an ultraviolet-curing acrylic resin resist film CB-2000 (manufactured by Fujifilm Olin Co., Ltd.), in which a blue pigment is dispersed, is formed. In the steps of forming the color filter layers 24 (R, G, B), through-holes 26 and contact holes 81 are formed at the same time.

After pixel electrodes 151 are formed, columnar spacers 31 (R, G, B) for creating desired gaps at the respective color pixels are formed. The steps of forming the columnar spacers are described below. A spacer material is formed on the substrate. For example, using a spinner, an ultraviolet-curing acrylic resin resist film NN600 (manufactured by JSR), in which a predetermined amount of a black pigment is added, is coated on the entire surface of the substrate to a desired film thickness. The spacer material is dried at 90° C. for 10 minutes. Then, the spacer material is patterned with different predetermined sizes in association with the respective gap regions. For example, using a photomask with a predetermined pattern, the spacer material is exposed with a wavelength of 365 nm at an exposure amount of 100 mJ/cm². The exposed spacer material is developed in an alkali aqueous solution with pH 11.5. Subsequently, the individually patterned portions of the spacer material are melted and the heights thereof are adjusted. For example, the spacer material that is left on the substrate after development is baked at 200° C. for 60 minutes. By the baking treatment, the spacer material is melted, and then cured/contracted. Thereby, columnar spacers 31 (R, G, B) with desired heights are formed.

In the case where a negative-type resin resist material, which is rendered insoluble by cross-linking using optical radiation, is used as the spacer material, a photomask that is used in the step of exposing the spacer material is configured as follows. The photomask includes a mask pattern with an opening of a relatively large first size, thereby to form the columnar spacer 31R for the red pixel. The photomask also includes a mask pattern with an opening of a second size, which is smaller than the first size, thereby to form the columnar spacer 31G for the green pixel. Further, the photomask includes a mask pattern with an opening of a third size, which is smaller than the second size, thereby to form the columnar spacer 31B for the blue pixel.

In the case where a positive-type resin resist material, which is rendered dissoluble by optical radiation, is used as the spacer material, a photomask that is used in the step of exposing the spacer material is configured as follows. The photomask includes a mask pattern with a shield portion of a relatively large first size, thereby to form the columnar spacer 31R for the red pixel. The photomask also includes a mask pattern with a shield portion of a second size, which is smaller than the first size, thereby to form the columnar spacer 31G for the green pixel. Further, the photomask includes a mask pattern with a shield portion of a third size, which is smaller than the second size, thereby to form the columnar spacer 31B for the blue pixel.

Thereby, the spacer material is patterned with the relatively large first size in association with the gap region of the red pixel. At the same time, the spacer material is patterned with the second size that is smaller than the first size in association with the gap region of the green pixel, and the spacer material is patterned with the third size that is smaller than the second size in association with the gap region of the blue pixel.

Thereby, the columnar spacer 31R having a bottom size of 25 μm×25 μm and a height of about 5.0 μm is formed in the gap region of the red pixel. The columnar spacer 31G having a bottom size of 20 μm×20 μm and a height of about 4.6 μm is formed in the gap region of the green pixel. Further, the columnar spacer 31B having a bottom size of 15 μm×15 μm and a height of about 4.0 am is formed in the gap region of the blue pixel.

In the above-described fabrication steps of the columnar spacers 31 (R, G, B), the developed resist material is baked. Thereby, the columnar spacers with different magnitudes, which are left on the substrate, are melted to different heights, and then cured and contracted. The height that varies in curing/contraction is different depending on the magnitude of the columnar spacer. In this embodiment, the material is baked and melted at 200° C. for 60 minutes, and then the material is cured and contracted. Other methods may be adopted as conditions for melting. For instance, a method of adjusting the rate of temperature rise can be adopted.

In the process of forming the columnar spacers 31 (R, G, B), the shield layer SP is formed at the same time. The photomask, which is used in the exposure step of the resist material, includes a mask pattern that corresponds to the shield layer SP. The shield layer SP may be formed of a blue resin. In this case, the shield layer SP and the blue color filter layer 24B can be formed at the same time, and this can reduce the number of fabrication steps. Subsequently, a vertical alignment film material SE-7511L (manufactured by NISSAN CHEMICAL INDUSTRIES, LTD.) is coated on the entire surface of the substrate. The coated material is baked, and an alignment film 13A is formed. Thereby, the array substrate 100 is fabricated.

On the other hand, in the process of fabricating the counter electrode 200, a counter electrode 22 is formed on an insulative substrate 21. Then, a vertical alignment film material SE-7511L (manufactured by NISSAN CHEMICAL INDUSTRIES, LTD.) is coated on the entire surface of the substrate. The coated material is baked, and an alignment film 13B is formed. Thereby, the counter substrate 200 is fabricated.

In the process of manufacturing the liquid crystal display panel 10, a seal material 106 is applied, by printing, along the outer peripheral edge of the array substrate 100. In this case, the seal material 106 is applied such that a liquid crystal injection port 32 is formed. Thereafter, an electrode transfer material for applying a voltage from the array substrate 100 to the counter electrode 204 is formed on an electrode-transfer electrode around the seal material 106. The array substrate 100 and counter substrate 200 are positioned such that the alignment film 13A of the array substrate 100 and the alignment film 13B of the counter substrate 200 are opposed to each other. Both substrates are pressed and heated, and the seal material 106 is cured. Thereby, both substrates are bonded. Then, a liquid crystal composition MLC-2039 (manufactured by MERCK) is injected from the liquid crystal injection port 32. The liquid crystal injection port 32 is sealed by a seal member 33. Thus, the liquid crystal layer 300 is formed.

The liquid crystal display panel is manufactured by the above-described method. In addition to the present embodiment, the following display modes, for instance, can be adopted in the liquid crystal display apparatus: TN (twisted nematic) mode, ST (supertwisted nematic) mode, GH (guest-host) mode, ECB (electrically controlled birefringence) mode, and ferroelectric liquid crystal mode.

The color liquid crystal display apparatus manufactured by the above method has the multi-gap structure having such desired gaps that a maximum transmittance is obtained in accordance with the dominant wavelength of light that passes through the liquid crystal layer 300. Moreover, good viewing angle characteristics are attained, and an excellent display quality is obtained.

In order to form the multi-gap structure, the columnar spacers with different heights can be formed of the same material in the same step. Therefore, the manufacturing cost can be reduced and the manufacturing yield increased. Moreover, since the color filter layers and columnar spacers are integrally formed on one of the substrates, it is possible to solve the problem with the use of spherical or cylindrical spacers and to improve the display quality.

The present invention is not limited to the above-described embodiment, and various modifications can be made. Other modifications of the present invention will be described below. The structural parts common to those in the above-described embodiment are denoted by like reference numerals, and a detailed description is omitted.

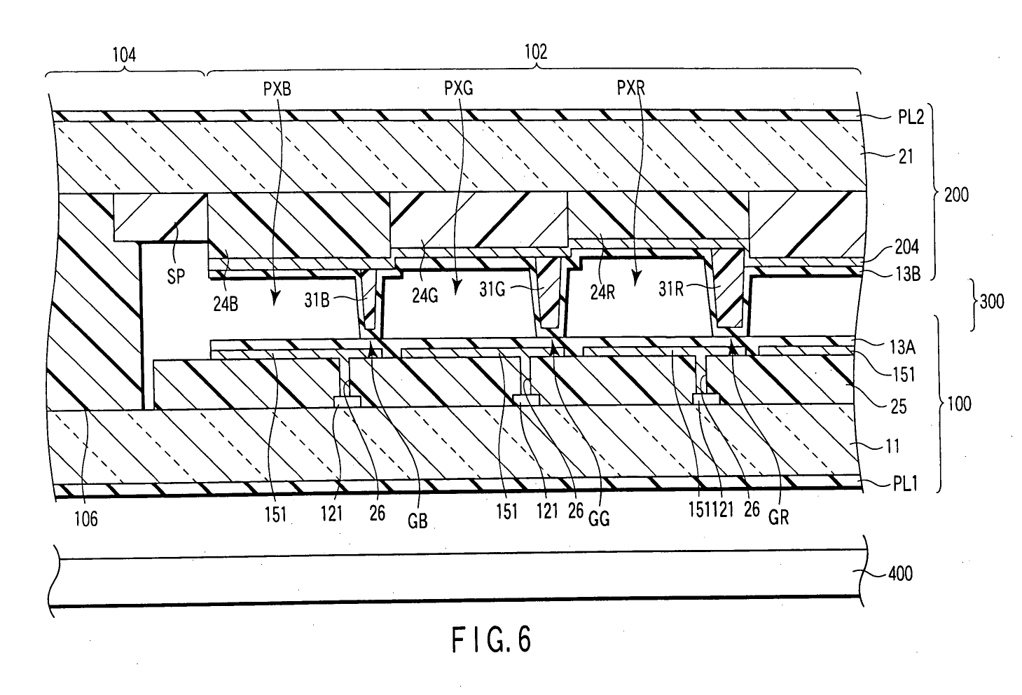

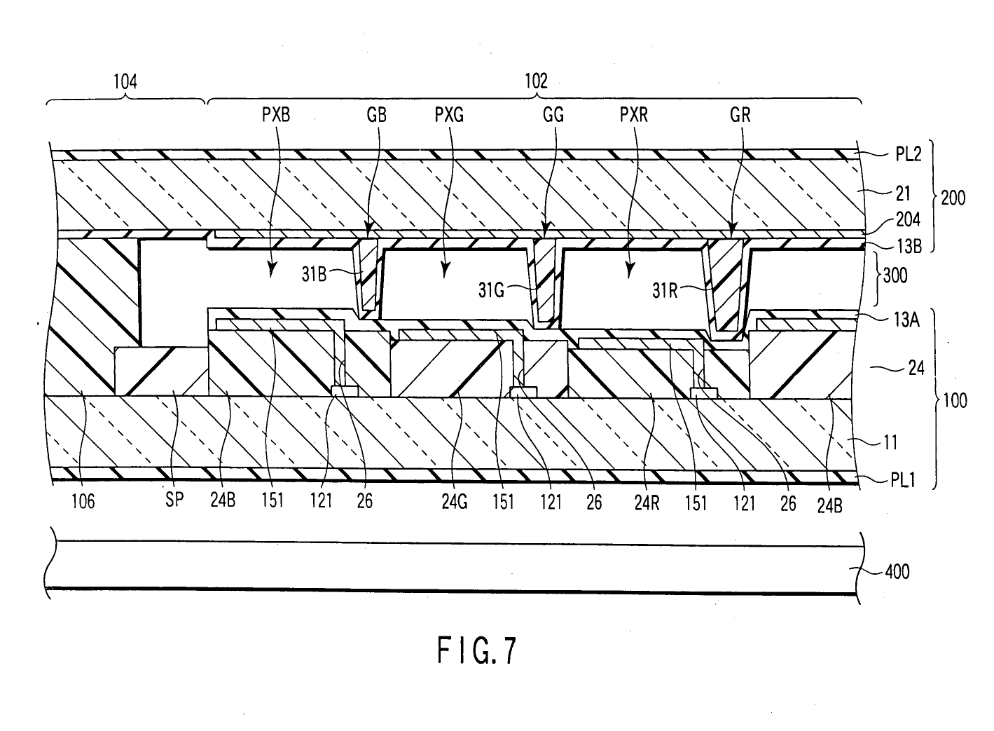

FIG. 6 shows an array substrate 100 of a liquid crystal display panel 10 according to another embodiment of the invention. In the display region 102, the array substrate 100 includes, on the transparent insulative substrate 11, pixel TFTs 121 that are formed in association with a plurality of pixels arranged in a matrix, an insulation layer 25 that is disposed to cover the display region 102 including the pixel TFTs 121, pixel electrodes 151 that are disposed on the insulation layer 25 and connected to the pixel TFTs 121 via through-holes 26, and an alignment film 13A that is disposed to cover the entire pixel electrodes 151.

The counter substrate 200 includes color filter layers 24 (R, G, B) that are formed in association with the respective pixels on the transparent insulative substrate 21 in the display region 102. In addition, the counter substrate 200 also includes a counter electrode 204 that is formed on the color filter layers 24 (R, G, B) and is provided commonly for all the pixels, and an alignment film 13B that is disposed to cover the counter electrode 204. In addition, the counter electrode 200 includes a shield layer SP that is disposed on the peripheral region 104 along the outer periphery of the display region 102. The counter substrate 200 includes columnar spacers 31 (R, G, B) that are disposed on the color filter layers 24 (R, G, B) and are suited to the multi-gap structure.

The color filter layers 24 (R, G, B) have different film thicknesses in accordance with the associated colors, and the following relationship is established:

film thickness of red color filter layer<film thickness of green color filter layer<film thickness of blue color filter layer.

In addition, the columnar spacers 31 (R, G, B) are different between the gap regions where they are disposed, and the following relationship is established:

columnar spacer 31R>columnar spacer 31G>columnar spacer 31B.

The above-mentioned multi-gap structure is described in greater detail. For example, in the structure shown in FIG. 6, attention is paid to the red pixel PXR and blue pixel PXB.

The counter substrate (first substrate) 200 includes the red color filter layer (first color filter layer) 24R in association with the red pixel PXR, and includes the first columnar spacer 31R in association with the first gap region GR. In addition, the counter substrate 200 includes the blue color filter layer (second color filter layer) 24B in association with the blue pixel PXB, and includes the second columnar spacer 31B in association with the second gap region GB.

The red color filter layer 24R has a first film thickness. The blue color filter layer 24B has a second film thickness, which is greater than the first film thickness. The first columnar spacer 31R is disposed on the red color filter layer 24R, and contacts the array substrate (second substrate) 100 and creates a first gap for interposition of the liquid crystal layer 300 between the array substrate 100 and counter substrate 200. The second columnar spacer 31B is disposed on the blue color filter layer 24B, and contacts the array substrate 100 and creates a second gap, which is smaller than the first gap, for interposition of the liquid crystal layer 300 between the array substrate 100 and counter substrate 200. Needless to say, the sum of the first film thickness of the red color filter layer 24R and the first height of the columnar spacer 31R is substantially equal to the sum of the second film thickness of the blue color filter layer 24B and the second height of the columnar spacer 31B. Thereby, a desired multi-gap structure can be formed.

With the liquid crystal display apparatus having the above structure, the same advantages as with the preceding embodiment can be obtained.

FIG. 7 shows an array substrate 100 of a liquid crystal display panel 10 according to another embodiment of the invention. In the display region 102, the array substrate 100 includes, on the transparent insulative substrate 11, pixel TFTs 121 that are formed in association with a plurality of pixels arranged in a matrix, color filter layers 24 (R, G, B) that are formed in association with the respective pixels, pixel electrodes 151 that are disposed on the color filter layers 24 (R, G, B) and connected to the pixel TFTs 121 via through-holes 26, and an alignment film 13A that is disposed to cover the entire pixel electrodes 151.

The counter substrate 200 includes, on the transparent insulative substrate 21 in the display region 102, a counter electrode 204 that is provided commonly for all the pixels, and an alignment film 13B that is disposed to cover the counter electrode 204. In addition, the counter electrode 200 includes columnar spacers 31 (R, G, B) that are disposed above the color filter layers 24 (R, G, B) and are suited to the multi-gap structure.

The color filter layers 24 (R, G, B) have different film thicknesses in accordance with the associated colors, and the following relationship is established:

film thickness of red color filter layer<film thickness of green color filter layer<film thickness of blue color filter layer.

In addition, the columnar spacers 31 (R, G, B) are different between the color pixels where they are disposed, and the following relationship is established:

columnar spacer 31R>columnar spacer 31G>columnar spacer 31B.

The above-mentioned multi-gap structure is described in greater detail. For example, in the structure shown in FIG. 7, attention is paid to the red pixel PXR and blue pixel PXB.

The array substrate (first substrate) 100 includes the red color filter layer (first color filter layer) 24R in association with the red pixel PXR, and includes the blue color filter layer (second color filter layer) 24B in association with the blue pixel PXB. The counter substrate (second substrate) 200 includes the first columnar spacer 31R in association with the first gap region GR of the red pixel PXR. In addition, the counter substrate 200 includes the second columnar spacer 31B in association with the second gap GB of the blue pixel PXB.

The red color filter layer 24R has a first film thickness. The blue color filter layer 24B has a second film thickness, which is greater than the first film thickness. The first columnar spacer 31R contacts the red color filter layer 24R and creates a first gap for interposition of the liquid crystal layer 300 between the array substrate 100 and counter substrate 200. The second columnar spacer 31B contacts the blue color filter layer 24B and creates a second gap, which is smaller than the first gap, for interposition of the liquid crystal layer 300 between the array substrate 100 and counter substrate 200. Needless to say, the sum of the first film thickness of the red color filter layer 24R and the first height of the columnar spacer 31R is substantially equal to the sum of the second film thickness of the blue color filter layer 24B and the second height of the columnar spacer 31B. Thereby, a desired multi-gap structure can be formed.

With the liquid crystal display apparatus having the above structure, the same advantages as with the preceding embodiment can be obtained.

The above-described embodiments are directed to transmission-type liquid crystal panels. The same advantages as with the above-described embodiments, however, can be obtained even where the invention is applied to reflection-type liquid crystal panels.

In the liquid crystal display apparatus according to the present invention, in order to form the multi-gap structure, a plurality of columnar spacers are provided. The columnar spacers have heights corresponding to the respective gaps of the multi-gap structure. The heights of the columnar spacers can be controlled by the magnitudes of the columnar spacers. In each of the embodiments, the height of the columnar spacer is controlled by the contact area of the bottom part of the columnar spacer, which contacts the substrate. For example, a columnar spacer, which is patterned to have a relatively large contact area, has a relatively great height. On the other hand, a columnar spacer, which is patterned to have a relatively small contact area, has a relatively small height.

That the height of the columnar spacer can be controlled by the magnitude of the contact area means that the height of the columnar spacer can be controlled by the dimensions or volume of the columnar spacer. Specifically, a columnar spacer, which is formed to have a relatively large dimensions, has a relatively great height. On the other hand, a columnar spacer, which is formed to have a relatively small dimensions, has a relatively small height. Besides, a columnar spacer, which is formed to have a relatively large volume, has a relatively great height, and a columnar spacer, which is formed to have a relatively small volume, has a relatively small height.

Using the columnar spacers with different dimensions or volumes, the multi-gap structure can be formed like the above-described embodiments.

### COMPARATIVE EXAMPLE 1

A liquid crystal display apparatus was fabricated. This apparatus is similar to the liquid crystal display apparatus according to the embodiment shown in FIG. 3, except that all the columnar spacers 31 (R, G, B) are formed such that the bottom surface of each columnar spacer has a magnitude of 20 μm×20 μm. The fabricated liquid crystal display apparatus was evaluated. It was found that all the columnar spacers 31 (R, G, B) had the same height and the multi-gap structure could not be realized. Due to a defect in gap, color viewing angle characteristics were considerably degraded.

### COMPARATIVE EXAMPLE 2

A liquid crystal display apparatus was fabricated. This apparatus is similar to the liquid crystal display apparatus according to the embodiment shown in FIG. 3, except that only the columnar spacer 31R is disposed and the other columnar spacers 31G and 31B are not formed. The fabricated liquid crystal display apparatus was evaluated. It was found that the support strength by the columnar spacer deteriorated and an irreversible gap defect occurred in parts. As a result, a partial display defect occurred, and the display quality considerably deteriorated.

As has been described above, according to the liquid crystal display apparatus of the present invention and the method of manufacturing this liquid crystal display apparatus, color filter layers with predetermined film thicknesses are formed in association with the respective colors. Making use of the difference in film thickness of the color filter layers, a multi-gap structure is realized. The multi-gap structure has such a desired gap that the transmittance of light that passes through the liquid crystal layer can take a maximum value. In addition, the columnar spacers, which have such heights as to compensate the difference in film thickness of the color filter layers, are disposed. Thereby, the predetermined gaps at the respective pixels can be ensured with sufficient support strength. Therefore, good viewing angle characteristics are attained, and an excellent display quality is obtained.

As regards the process of forming the columnar spacers, attention is paid to the fact that the height of the columnar spacer is controllable by the size of patterning of the spacer material, and the columnar spacers with different heights can be formed of the same material in the same step. Thus, the manufacturing cost can be reduced and the manufacturing yield increased.

Therefore, it is possible to provide a liquid crystal display apparatus, which can achieve a high manufacturing yield at low cost, and can realize a high display quality.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display apparatus configured to have a liquid crystal layer interposed between a first substrate and a second substrate, characterized by comprising:
a first gap region with a first gap for interposition of the liquid crystal layer between the first substrate and the second substrate;
a second gap region with a second gap that is smaller than the first gap;
a first columnar spacer that is formed in the first gap region on the first substrate; and
a second columnar spacer that is formed in the second gap region on the first substrate,
wherein a contact area of the first columnar spacer, which contacts the first substrate, is greater than a contact area of the second columnar spacer, which contacts the first substrate.

2. The liquid crystal display apparatus according to claim 1, characterized in that the first gap region includes a first color filter layer that mainly passes first color light, the second gap region includes a second color filter layer that mainly passes second color light, and the first color light has a wavelength that is greater than a wavelength of the second color light.

3. The liquid crystal display apparatus according to claim 1, characterized in that the first substrate includes, in the first gap region, a first color filter layer that mainly passes first color light, and includes, in the second gap region, a second color filter layer that mainly passes second color light.

4. The liquid crystal display apparatus according to claim 1, characterized in that the first substrate includes scan lines disposed in a row direction, signal lines disposed in a column direction, switching elements disposed near intersections of the scan lines and the signal lines, and pixel electrodes that are connected to the switching elements and are disposed in a matrix.

5. The liquid crystal display apparatus according to claim 1, characterized in that the first substrate includes a light shield layer that is formed in a picture-frame shape along a peripheral edge of a display region, and the first columnar spacer, the second columnar spacer and the light shield layer are formed of the same material.

6. The liquid crystal display apparatus according to claim 1, characterized in that the first substrate includes a counter electrode that is common for all pixels.

7. A liquid crystal display apparatus configured to have a liquid crystal layer interposed between a first substrate and a second substrate, characterized by comprising:
a first gap region with a first gap for interposition of the liquid crystal layer between the first substrate and the second substrate;
a second gap region with a second gap that is smaller than the first gap;
a first columnar spacer that is formed in the first gap region on the first substrate; and
a second columnar spacer that is formed in the second gap region on the first substrate,
wherein a dimensions of the first columnar spacer is greater than a dimensions of the second columnar spacer.

8. The liquid crystal display apparatus according to claim 7, characterized in that the first gap region includes a first color filter layer that mainly passes first color light, the second gap region includes a second color filter layer that mainly passes second color light, and the first color light has a wavelength that is greater than a wavelength of the second color light.

9. The liquid crystal display apparatus according to claim 7, characterized in that the first substrate includes, in the first gap region, a first color filter layer that mainly passes first color light, and includes, in the second gap region, a second color filter layer that mainly passes second color light.

10. The liquid crystal display apparatus according to claim 7, characterized in that the first substrate includes scan lines disposed in a row direction, signal lines disposed in a column direction, switching elements disposed near intersections of the scan lines and the signal lines, and pixel electrodes that are connected to the switching elements and are disposed in a matrix.

11. The liquid crystal display apparatus according to claim 7, characterized in that the first substrate includes a light shield layer that is formed in a picture-frame shape along a peripheral edge of a display region, and the first columnar spacer, the second columnar spacer and the light shield layer are formed of the same material.

12. The liquid crystal display apparatus according to claim 7, characterized in that the first substrate includes a counter electrode that is common for all pixels.

13. A liquid crystal display apparatus configured to have a liquid crystal layer interposed between a first substrate and a second substrate, characterized by comprising:
a first gap region with a first gap for interposition of the liquid crystal layer between the first substrate and the second substrate;
a second gap region with a second gap that is smaller than the first gap;
a first columnar spacer that is formed in the first gap region on the first substrate; and
a second columnar spacer that is formed in the second gap region on the first substrate,
wherein a volume of the first columnar spacer is greater than a volume of the second columnar spacer.

14. The liquid crystal display apparatus according to claim 13, characterized in that the first gap region includes a first color filter layer that mainly passes first color light, the second gap region includes a second color filter layer that mainly passes second color light, and the first color light has a wavelength that is greater than a wavelength of the second color light.

15. The liquid crystal display apparatus according to claim 13, characterized in that the first substrate includes, in the first gap region, a first color filter layer that mainly passes first color light, and includes, in the second gap region, a second color filter layer that mainly passes second color light.

16. The liquid crystal display apparatus according to claim 13, characterized in that the first substrate includes scan lines disposed in a row direction, signal lines disposed in a column direction, switching elements disposed near intersections of the scan lines and the signal lines, and pixel electrodes that are connected to the switching elements and are disposed in a matrix.

17. The liquid crystal display apparatus according to claim 13, characterized in that the first substrate includes a light shield layer that is formed in a picture-frame shape along a peripheral edge of a display region, and the first columnar spacer, the second columnar spacer and the light shield layer are formed of the same material.

18. The liquid crystal display apparatus according to claim 13, characterized in that the first substrate includes a counter electrode that is common for all pixels.

19. A method of manufacturing a liquid crystal display apparatus configured to have a liquid crystal layer interposed between a first substrate and a second substrate, characterized by comprising:
forming a spacer material on the first substrate;
patterning the spacer material with a first size in accordance with a first gap region that includes a first gap for interposition of the liquid crystal layer, and patterning the spacer material with a second size, which is smaller than the first size, in accordance with a second gap region that includes a second gap, which is smaller than the first gap; and
melting the spacer material that is patterned in each of the first gap region and the second gap region, and adjusting a height of the spacer material patterned in the first gap region and a height of the spacer material patterned in the second gap region.
